(19) United States
(12) Patent Application Publication
(10) Pub. No.: US 2012/0236286 A1
(43) Pub. Date: Sep. 20, 2012

(54) ACCURATE GUN BORESIGHTING SYSTEM

(76) Inventor: Michael R. Layton, Clayton, CA (US)

(21) Appl. No.: 13/051,676

(22) Filed: Mar. 18, 2011

(51) Int. Cl. G01C 3/08

(52) U.S. Cl. 356/4.01

(57) ABSTRACT

A device including an optical laser radiation source that emits laser radiation having a radially symmetric intensity profile and a mounting structure that engages a weapon barrel. An optical receiver including photodetectors located equidistant from and surrounding a central target site is locatable remote from the weapon. The photodetectors are sensitive to the laser radiation and each photodetector generates an electrical signal proportional to an intensity of the laser radiation received from the laser radiation source. A signal processor processes the electrical signals from the photodetectors to generate an intensity gradient indicating comparative intensity of the laser radiation that is detected by the photodetectors. The intensity gradient presents a null point when the intensity detected by at least two compared photodetectors is equal. A communicative link exists between the optical laser radiation source and the optical receiver. Synchronous modulation-demodulation of the laser source and detectors assists in optical noise exclusion.

### FIELD OF THE INVENTION

The invention relates to the boresighting of guns. More specifically, the invention relates to boresighting to align an optical sight with the barrel of a gun at a selected target distance.

### BACKGROUND OF THE INVENTION

Boresighting involves adjusting the elevation and azimuth pointing directions of both a weapon and an optical sight coupled to the weapon such that they are coincident at a particular range. Parallax effects between the sight and the weapon barrel vary depending on the distance of the weapon and sight from the target.

One common and well established method used in boresighting large caliber weapons is to install an optical telescopic sight coaxially in the weapon barrel and to have a human operator look through the telescope eye piece and adjust the weapon in elevation and azimuth until the telescope crosshairs are centered on a target. Once the optical telescopic sight mounted in the weapon bore is accurately pointed at the target, the optical sight associated with the weapon is then similarly adjusted until the crosshairs of the optical sight are also centered on the target.

The intention of boresighting is to obtain a rough coincidence between the direction in which the bore of the weapon is pointed and the direction in which the optical sight associated with the weapon is pointed. This causes the aiming point of the optical sight and the weapon to be approximately coincident so that the accuracy of the aiming sight can be further adjusted by test firing the weapon.

The accuracy of the above discussed method is dependent upon the ability of the operator to clearly see the crosshairs of the optical telescope and to judge when the crosshair reticle is properly aligned with the target. The above discussed method is limited and subject to errors primarily due to the difficulties in judging the alignment of the crosshairs with the target at longer ranges. Further, the above discussed method is only usable in daylight or at night with an illuminated target.

To implement the above discussed method, the operator must repeatedly view the target while the weapon's direction is adjusted. This method typically requires two people, one person to look through the optical telescope to judge alignment with the target and the second person to adjust the weapon's direction based on the instructions of the telescope viewer. It is possible for one person to perform the above discussed operation, if a camera system is added to the telescope and a video display is presented to the person adjusting the position of the weapon.

Another known method for boresighting is to use a visible-light laser beam with narrow beam divergence. For example, a helium-neon (He—Ne) or diode laser operating at 633 nm wavelength can be used. In this method, the laser is mounted coaxially with the weapon, typically inside the weapon's barrel, and the weapon's elevation and azimuth are adjusted until the laser generated light spot illuminates the center of a target. Then, the optical sight for the weapon is adjusted to coincide with the laser spot projected on the target.

This method has a number of limitations. The use of the visible laser may present a safety hazard to the eyes of the individuals working in proximity to the boresighting activities. This method also requires feedback from the target location toward which the laser beam is directed. For example, a second operator with a radio may communicate with the first operator at the weapon's location or a video camera may be trained on the target and a monitor is located where it is visible to the operator of the weapon. Feedback must be provided to the person adjusting the weapon pointing direction so that they know the location of the laser spot on the target at a distance. This method may not be usable at night without access to an illuminated target because of the initial difficulty in placing the laser spot proximate the target. The laser boresighting method has the advantages of simplicity and demonstrated good accuracy in placing the laser spot on the center of the target.

Other methods of boresighting may exist as well.

### SUMMARY OF THE INVENTION

The invention relates to a device and a method for boresighting a weapon where the goal of the boresighting operation is to align the pointing direction of the weapon to that of an optical sight associated with the weapon at a chosen range. The invention provides an objective technique to accurately aim the weapon being boresighted at a target that minimizes the effect of human judgment on the process.

Boresighting of a weapon requires determining the direction in which the weapon is pointed to a high degree of accuracy. The invention addresses that need by providing an apparatus and a method for very accurate alignment of the elevation and azimuth of a weapon relative to a distant target. The invention provides improved sensitivity to misalignment over prior art methods because it utilizes a gradient method in which a null signal is the end result. Slight movements of the weapon's pointing direction away from the null position result in a rapidly increasing error signal in accordance with the invention. Furthermore, the method of the invention, unlike methods that seek to identify a peak intensity of a laser, is insensitive to variations in the optical source amplitude.

The device of the invention generally includes an optical source that is adapted to be mounted coaxially within or parallel to the weapon barrel, an optical receiver including a photodetector array and signal processing electronics, a low power radio link communicatively coupling the optical source and the optical receiver and a display located at the weapon for viewing by the operator of the system.

In one example embodiment, the optical source may include a single mode 1.55 micron wavelength laser. One reason for using this type of laser is that it provides a gaussian radial intensity profile surrounding the pointing direction. Another reason for using this type of laser is that it is eye safe and will not harm the eyes of observers that may be exposed to it. In one embodiment of the invention, the optical receiver includes four identical photoreceptors that are located at the target. The signal processing electronics of the optical receiver are adapted to detect the intensity of the laser energy directed at the target that falls on each photodetector. The electronics are also adapted to differentially process signals in azimuth and elevation so that a null or minimum result is indicative of being on target. The invention can also be implemented with three photoreceptors located at one hundred twenty degree spacing around a distant target though this arrangement makes the mathematics of determining which way to direct the operator to correct for bore sighting error more complex.

According to an example embodiment of the invention, the use of the gaussian radial intensity pattern laser beam with appropriate detector spacing and location assists in assuring that the gradient signal provides a clear indication of where the beam is directed as compared to the desired on-target location. For example, the indication clearly identifies whether the beam is high or low or to the left or right of the desired target location.

According to an example embodiment, the laser source is modulated either sinusoidally or in a square wave fashion at a selected frequency. The detected signal is demodulated at the same frequency as the modulation of the laser source, thus resulting in high selectivity and excellent rejection of background noise.

According to an embodiment of the invention, a radio link is used to provide communication between the source and the target to provide the receiving electronics with the reference oscillator modulation frequency.

The device and method of the present invention are well suited for applications where frequent boresighting operations are performed. Such applications may include production testing or government range testing where the target including four photo detectors and electronics can be permanently installed. The optical and electronic features of the invention are expected to result in a robust and accurate method for precise boresight aligning of a weapon to a target.

While the invention is described herein in the context of boresighting of weapons, the invention may also have applicability to laser systems used in training, in which coded laser signals are used to simulate weapons firing and targets are outfitted with detector arrays.

In one embodiment of the invention, improved sensitivity to misalignment may be achieved because the invention utilizes a gradient method wherein a null signal is achieved between two or more photoreceptors as the desired output when the weapon is properly aimed for boresighting. In accordance with one embodiment of the invention, even a slight movement away from the null location results in a rapidly increasing error signal.

Embodiments of the invention permit boresighting without any subjective judgment regarding the boresighted weapon's pointing direction. The boresighting device and method of the invention provide a laser based boresighting technique that is expected to be safe for the eyes of personnel in the area where the technique is being carried out. The present invention also permits boresighting to be accomplished by a single operator without the need for support personnel at the distant target location. Only an operator located at the weapon needs to be available. The device and method the present invention also provides a boresighting method that is usable either by day or by night and is minimally affected by a wide range of weather and lighting conditions. Contrary to the known prior art, the null point detection utilized in the invention is based on finding a null or minimum signal when proper boresighting alignment is achieved rather than a maximum.

In many circumstances, a weapon and its optical sight are separate subsystems. For example, in military armored vehicles such as tanks, the weapon is part of one subsystem and the optical sight a separate subsystem. During boresighting, the weapon is first pointed at a target and then the sight is adjusted until it is also pointed at the target. In one example embodiment of the invention, the optical light source may include a laser diode emitting radiation at a 1.55 micron wavelength. Other lasers emitting at other wavelengths may be utilized as well. According to an embodiment of the invention, the laser diode may be pigtailed to a length of single mode optical fiber that is designed such that only the lowest order TEM₀₀ wave guide mode is permitted to exit the fiber. In this embodiment, the fiber pigtail acts a mode stripper and removes undesirable higher order modes leaving only the radially symmetric gaussian TEM₀₀ mode exiting the fiber. Pigtailed 1.55 micron laser diodes are readily available commercially from a number of suppliers.

According to one embodiment of the invention, a lens or lens system is used to focus the light emitted from the fiber into a weakly diverging beam that projects the radial gaussian intensity profile of the laser in the direction that the weapon is pointed. According to one embodiment of the invention, the optical source is secured in a mechanical housing that can be mounted inside the barrel of the weapon or at the end of the barrel of the weapon such that the axis of the laser beam is precisely aligned with the weapon's bore axis. A variety of methods for making such a fixation, exist in the prior art. For example, spring loaded tapered mandrels that slide into the gun barrel can be employed to position the optical laser source.

According to one embodiment of the invention, the laser diode is modulated at a selected high frequency using either a square wave modulation or a sinusoidal modulation. Modulation of the laser beam on a high frequency carrier permits selective detection methods to be used at the receiver. Such selective detection methods are known to be used in lock-in ampliers and AM/FM radio for selectively detecting a small signal as compared to background noise. According to an embodiment of the invention, a reference signal that is phase locked (i.e. synchronous) to the modulating signal may be broadcast by a separate low power radio frequency signal to the receiver. The phase locked reference signal can be employed by the receiver to demodulate the detected optical beam.

An optical receiver, according to an embodiment of the invention, includes a photodetector array and signal processing electronics. The detector array is located at the target and includes two pairs of photodiodes that are designed for maximum sensitivity matching the wavelength of the laser source. The photodiodes are maximally sensitive at the 1.55 micron wavelength of the laser source in this example embodiment. According to the example embodiment, two diodes are placed at equal distances from the center of the target on opposite sides of the target in the azimuth direction and two diodes are placed at equal distances above and below the target center in the elevational direction. In one example, the separation between the azimuth detector pair is equal to the separation between the elevation detector pair.

Photodiodes receive discrete photons and convert them into discrete electrons via the photoelectric effect. Thus, photodiodes produce an electrical current that is proportional to the intensity of light radiation falling upon them. According to an example embodiment of the invention, the electrical current signal received is then demodulated by amplification, buffering and splitting into two identical signals. Each of the signals is then multiplied by an in-phase reference signal and quadrature square wave carrier reference signal that is synchronous with the laser modulating signal. According to another aspect of the invention, the signal processing approach can be similar for each of the four diode detector channels. The final output of the processing is a base band signal with very low bandwidth that represents the detected light intensity. The bandwidth may be on the order of a few hertz. In accordance with an embodiment of the invention, the signal processing continues with computation of an intensity gradient in the azimuth and the elevation direction. The azimuth gradient may be computed by taking the difference between outputs of the two azimuth diodes while the elevation gradient may be computed using the corresponding outputs of the two elevation diodes. The resultant gradient signals are then used to modulate a radio frequency carrier which is transmitted back to the weapon location.

In one example embodiment, the information may be communicated to the operator by a display which indicates which direction to move the weapon in azimuth or elevation to align the weapon to the target. According to one aspect of the invention, the gradient response is the same in elevation and azimuth because the beam is radially symmetrical and the detector spacings are set to be equal in both directions.

For example, considering azimuth, the system may be arranged so that when the laser beam misses the target to the left, the gradient signal is always positive and when the beam misses the target to the right, the gradient signal is always negative. According to the invention, only when the beam is centered on the target is a value of the gradient null or zero.

In accordance with the invention, a strong rate of change of the gradient about the null makes the method much more sensitive and accurate for determining target center as compared to methods that seek a maximum intensity of the laser signal at the target photodetector.

According to an embodiment of the invention, a laptop computer and display can be connected to the system that can be used to present signals relating to elevation and azimuth in a graphical form to the operator at the weapon location. The operator can use these indications to adjust the aiming of the weapon to achieve the null position. When the null position is achieved, the weapon is precisely aimed at the center of the target.

### BRIEF DESCRIPTION OF THE DRAWINGS

FIG. 1 is a partially perspective view, partially schematic view of a weapon and optical sight mounted on an armored vehicle directed toward a distant target;

FIG. 2 is a block diagram of an example embodiment in accordance with the invention.

FIG. 3 is a schematic depiction of a target including azimuth and elevational photodetectors according to an embodiment of the invention;

FIG. 4 is block diagram depicting signal processing performed by electronics associated with the target or receiver;

FIG. 5 is graphical representation of a Gaussian laser intensity distribution at the target;

FIG. 6 is graph representing an intensity gradient as compared to lateral position from the target's center of the laser beam; and

FIG. 7 is a schematic depiction of a boresighting system according to an embodiment of the inventions.

### DETAILED DESCRIPTION OF THE DRAWINGS

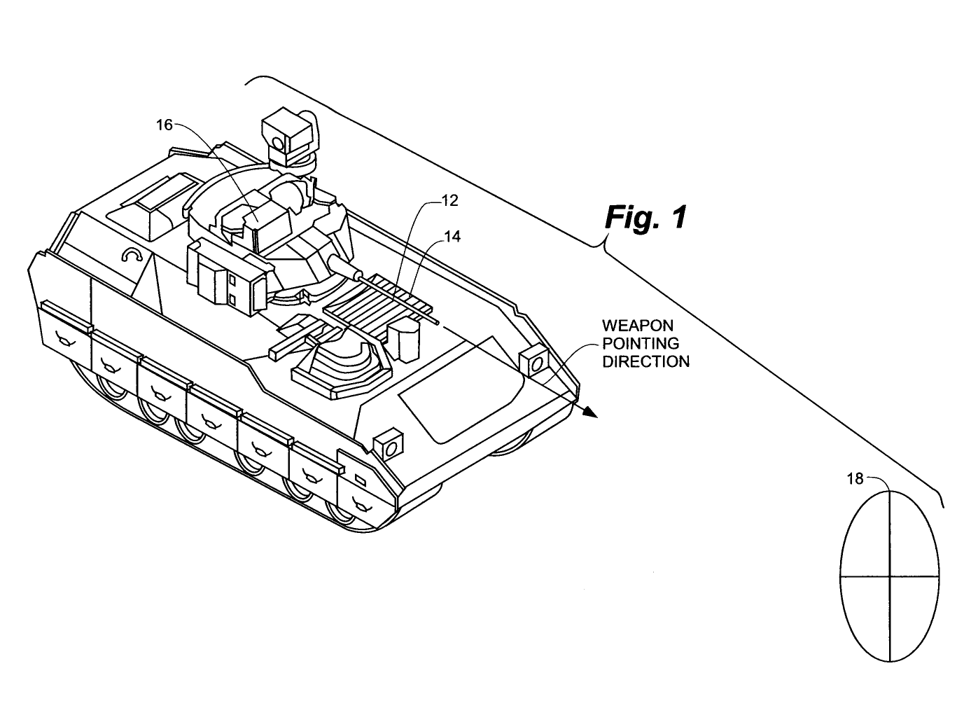

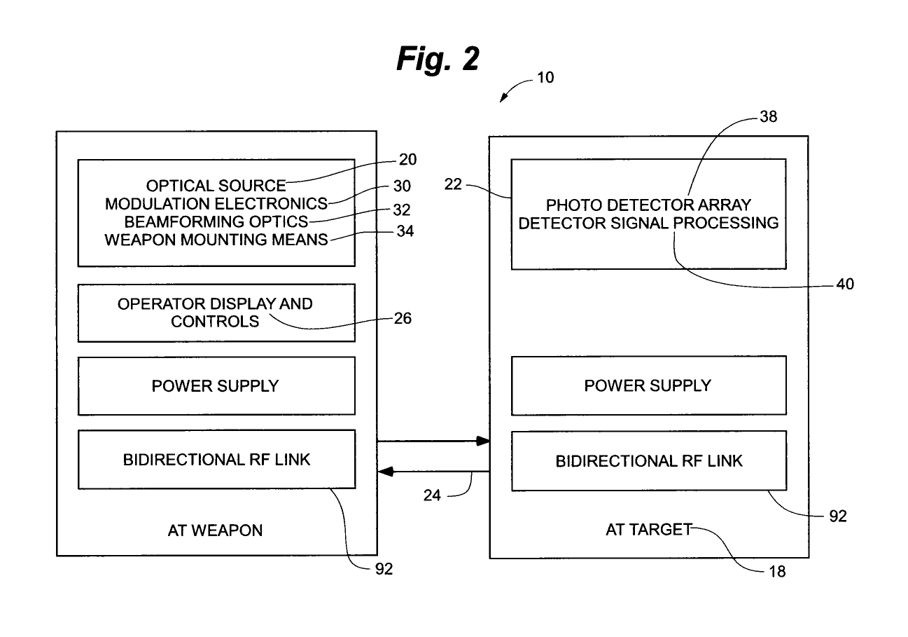

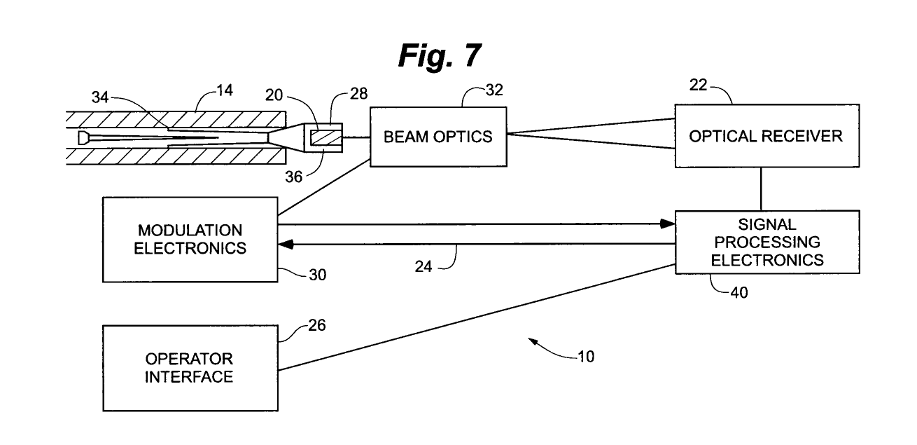

Boresighting system 10 as depicted in FIGS. 1 and 7, according to an embodiment of the invention is utilized with a weapon 12 including barrel 14 and optical sight 16. Boresighting system 10 according to the invention is used to align the central axis of barrel 14 with a distant target 18. The goal of boresighting and of the invention is to align the pointing direction of weapon 12 with that of optical sight 16 for a distant target 18 at a selected distance. Boresighting system 10 in accordance with the present invention generally includes some structures that are located at the weapon and some structures that are located at the target. Boresighting system 10 generally includes optical laser source 20, optical receiver 22, communication link 24 and operator interface 26 in one example embodiment. Referring to FIG. 2, optical laser source 20 includes laser source 28, modulation electronics 30, beam forming optics 32 and weapon mounting 34.

Laser source 28 may include laser diode 36. Laser diode 36 emits laser radiation, for example, at a 1.55 micron wavelength. While other wavelengths can be used, this wavelength is beneficial in that it is eye safe and should not harm individuals in the area that might be exposed to the laser radiation. According to an embodiment of the invention, the laser diode 36 is pigtailed to a length of single mode optical fiber designed such that only the lowest order TEM₀₀ wave guide mode is emitted from the laser diode. The fiber pigtail (not shown) acts as a mode stripper by removing undesired higher order modes of laser radiation permitting passage only of the radially symmetrical gaussian TEM₀₀ mode which exits the fiber. Pigtailed 1.55 micron laser diodes 36 are available commercially from a number of suppliers.

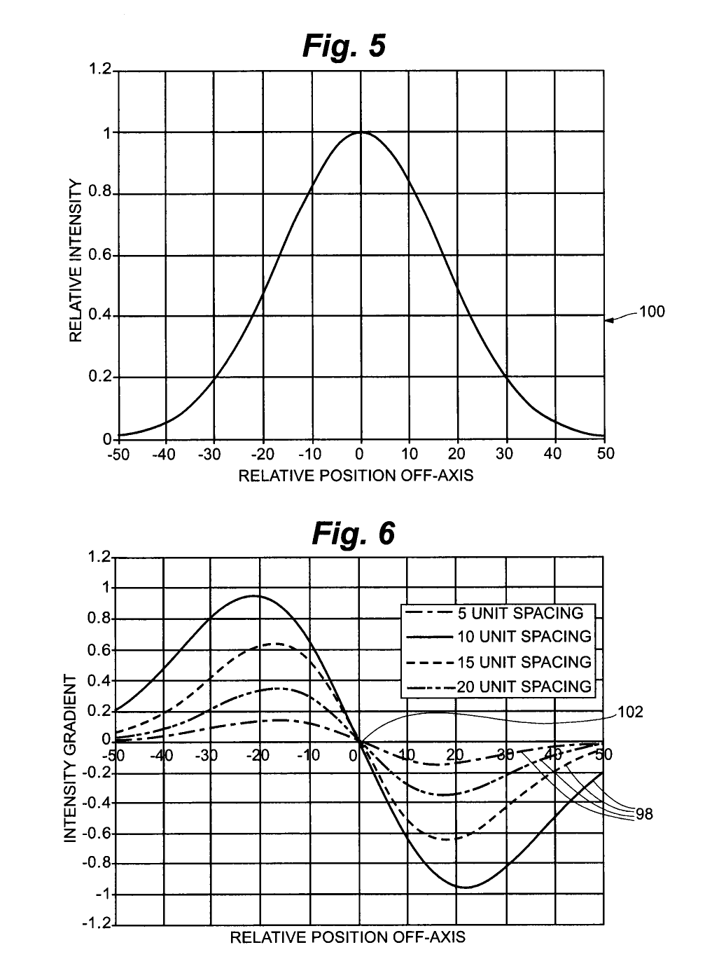

Beam forming optics 32 include a lens or lens system that focuses the emitted laser energy into a weakly diverging beam which is emitted in the direction which laser source 28 is pointed. The beam thus emitted has a radially symmetrical Gaussian intensity profile, a cross sectional graph of which is depicted in FIG. 5.

Modulation electronics 30 are adapted to modulate the output of laser source 28 at high frequency with, for example, a square wave modulation or a sinusoidal modulation.

Weapon mounting 34 is structured to precisely fix optical laser source 20, coaxially in, at or parallel to barrel 14 of weapon 12. Many prior art fixturing methods are available. For example, in example embodiment of the invention, spring loaded tapered mandrels that slide into the gun barrel can be utilized. Any approach that fixes optical laser source 20 accurately coaxially in the weapon bore is acceptable.

Optical receiver 22 generally includes photodetector array 38 and signal processing electronics 40.

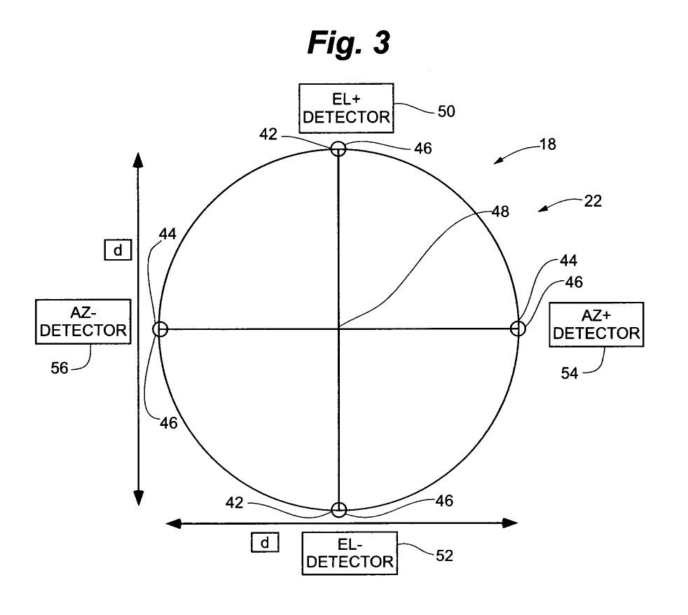

Referring to FIG. 3, an example photodetector array is schematically depicted. Photodetector array 38 is located at distant target 18, and in an example embodiment, includes elevation detector pair 42 and azimuth detector pair 44. Photodetector array 38 may include for example, four photodiodes 46 that have a maximum sensitivity matching that of the output of laser source 28. For example, photodiodes 26 have a maximum sensitivity at a 1.55 micron wavelength if laser source 28 emits at a 1.55 micron wavelength.

Referring again to FIG. 3, photodiodes 46 of elevation detector pair 42 are located equidistant from and on opposite sides of target center 48 in the elevation direction. Two photo diodes 46 of azimuth detector pair 44 are located equidistant and on opposite sides of target center 48 in the azimuth direction. Elevation detector pair 42 includes EL+ detector 50 and EL− detector 52. Azimuth detector pair 44 includes AZ+ detector 54 and AZ− detector 56.

Photodiodes 46 convert light energy in the form of discreet photons into electrical energy in the form of discreet electrons via the photo electric effect. This results in an electrical current from photodiodes 46 proportional to the light intensity falling on each photodiode.

Signal processing electronics 40 includes demodulation electronics 58. Demodulation electronics 58 demodulate the signal thus creating highly selective sensitivity to only the modulated laser beam arising from modulation electronics 30 and laser source 28.

In the described example embodiment of signal processing electronics 40, azimuth detector pair 44 and elevation detector pair 42 and provide signals to azimuth channel 60 and elevation channel 62 respectively.

Azimuth channel 60 includes AZ+ channel 64 and AZ− channel 66. Elevation channel 62 includes EL+ channel 68 and EL− channel 70. AZ+ channel 64, AZ− channel 66, EL+ channel 68 and EL− channel 70 are similar in structure and so AZ+ channel 64 will be described in detail with the understanding that AZ− channel 66, EL+ channel 68 and EL− channel 70 are similar in structure and the substructures within each of these channels will be identified by similar reference numerals.

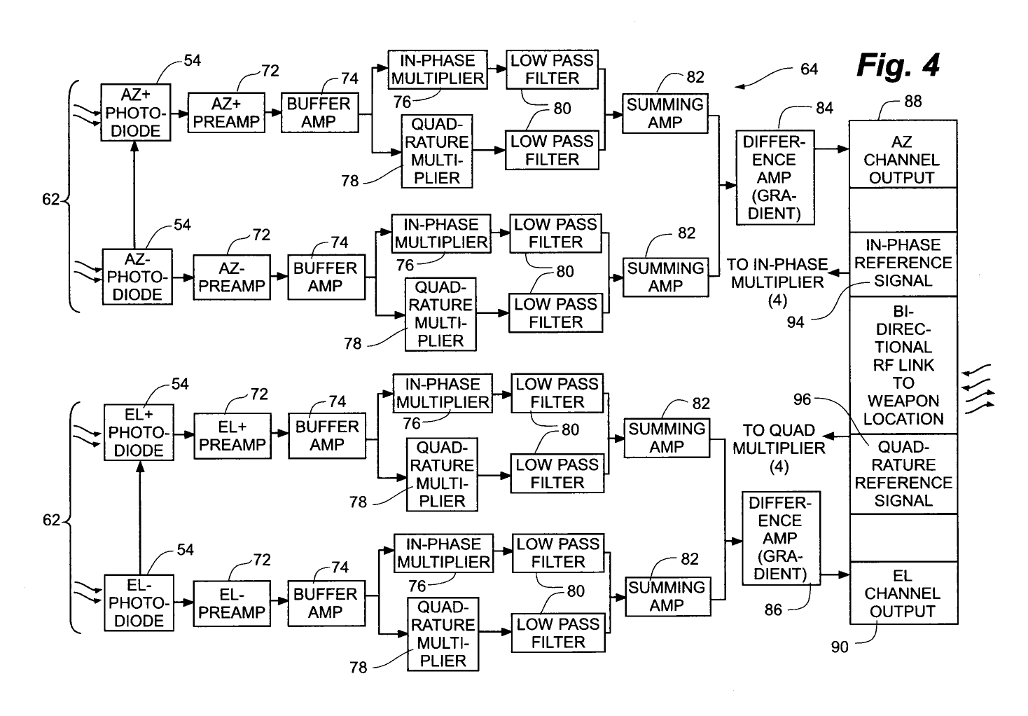

Referring to FIG. 4, AZ+ channel 64 includes preamplifier 72 which receives signals from AZ+ detector 54. The amplified signal from preamplifier 72 is fed to buffer amplifier 74. The output of buffer amplifier 74 is divided and directed to in phase multiplier 76 and quadrature multiplier 78. The output of in phase multiplier 76 is sent to first low pass filter 80. Similarly, the output of quadrature multiplier 78 is sent to second low pass filter 80. The outputs of first low pass filter 80 and second low pass filter 80 are combined and coupled to summing amplifier 82. As discussed above, the signal output of AZ− detector 56, EL+ detector 50 and EL− detector 52 are coupled through similar structures. Referring to FIG. 4 and azimuth channel 60, the outputs of the low pass filters 80 of AZ+ channel 64 and AZ− channel 66 are coupled into summing amplifiers 82. The output of each summing amplifier 82 is then directed to AZ difference amplifier 84. In a similar fashion, the output of EL+ channel 68 and EL− channel 70 is directed from summing amplifiers 82 to EL difference amplifier 86. The output of AZ difference amplifier 84 is directed to AZ channel output 88 and the output of EL difference amplifier 86 is directed to EL channel output 90.

Signal processing electronics 40 also includes generator for in phase reference signal 94 and generator for quadrature reference signal 96. In phase reference signal 94 is directed to four in phase multipliers 76 while quadrature reference signal 96 is directed to four quadrature multiplier 78.

As can be seen in FIG. 4, bidirectional RF link 92 is coupled via communication link 24 to modulation electronics 30. Signal processing electronics 40 is programmed to compute an intensity gradient in the azimuth and elevation directions. Referring to FIG. 6, an azimuth intensity gradient 98 is computed by taking the difference between the outputs of AZ+ channel 64 and AZ− channel 66. Similarly, elevation intensity gradient 98 is computed by taking the difference between EL+ channel 68 and EL− channel 70. The resulting intensity gradient signals 98 are returned via communication link 24 to the weapon location. The information thus supplied may be communicated to an operator via operator interface 26 to inform the operator which direction to move the weapon as azimuth or elevation to align the weapon with the target.

While the invention is illustrated and explained herein with a circuit diagram it is to be understood that after photodetection and first stage amplification, signals can be digitized and subsequent signal processing can be done digitally, for example by application of a microprocessor. In-phase reference signals 94 and quadrature reference signals 96 can also be digitized.

In accordance with the invention, FIG. 5 depicts a radial intensity profile of the output of laser diode 36 at the target. Gaussian laser beam profile 100 is a bell shaped curve having a central maximum that decays as 1/e² with radial distance away from the maximum.

FIG. 6 is a graph depicting the behavior of intensity gradient signal 98 for four different example separations of photodetector array 38. The detector separations are in normalized dimensions relative to the Gaussian laser beam width. In this example embodiment, gradient signal 98 response is similar in azimuth and elevation directions because the beam is radially symmetrical and the detector spacings are assumed to be equal in each direction. In the example graph, it is notable that when the beam is missing target 18 to the left, gradient signal 98 is always positive and when the beam is missing the target to the right, gradient signal 98 is always negative. Only when the beam is centered on target 18, is gradient signal null or a zero value. This fact and the strong rate of change of gradient signal 98 about the null or zero point 102, contribute to making this method highly sensitive for determining target center as compared for example to methods that seek a maximum intensity of the laser beam.

Operator interface 26 may include for example a laptop computer or other displays operably coupled to boresighting system 10.

It is notable that normalized dimensions have been used for the plotting of FIGS. 5 and 6 as well as in discussing the separations of photodiodes 46 and photodetector array 38. One of ordinary skill in the art will understand that optimum parameters for the beam width and detector spacing are dependent upon the range at which the system will be operated, the laser output power, the detector sensitivity and the level of noise at the receiver. The present invention assumes that weapon 12 can initially be pointed at the target within a reasonable margin of error sufficient so that the boresighting system 10 can detect the laser signal. Thereafter, feedback from boresighting system 10 is used by the operator to accurately dial in the boresighting of barrel 14. An appropriate initial margin of error would be approximately 10 mils or one-half of a degree. A raster scanning search method can be employed to initially find and lock onto the target, if necessary.

In operation, optical laser source 20 of boresighting system 10 is secured in barrel 14 of weapon 12. Optical laser source 20 is positioned so as to be coaxial with barrel 14 or can be secured to be parallel to the axis of barrel 14 if compensation is made for the off axis location of optical laser source 20. Optical receiver 22 is located at distant target 18 and barrel 14 of weapon 12 is directed approximately at optical receiver 22. Beam forming optics 32 modify the output of laser source 28 to provide a weekly diverging laser beam with a gaussian laser beam profile. The beam from laser source 28 is directed generally at optical receiver 22 located at distant target 18. It is generally understood and assumed in the context of the invention that weapon 12 can be initially aimed at the target within a reasonable error of approximately 10 mils or ½ degree. This initial aiming should be accurate enough to place the output of laser source 28 on optical receiver 22. Optical receiver 22 is dimensioned to make this achievable.

The beam from laser source 28 falling on photodetector array 38 will most likely be directed to the right or left of center as well as above or below the target. Accordingly, signal processing electronics 40 will send a signal to operator interface 26 via communication link 24. The signal provides an indication on operator interface 26 as to whether optical laser source 20 is directed at distant target 28 and whether the output of optical laser source 20 is for example left or right of center. Based on the information on operator interface 26 an operator boresighting weapon 12 can traverse weapon 12 and barrel 14 in an appropriate direction to center the output of optical laser source 20 on optical receiver 22. For example, centering is demonstrated when the output of AZ+ detector 54 and AZ− detector 56 is equal because equal intensity of laser light is falling on each. The outputs of AZ+ detector 54 and AZ− detector 56 are assigned opposite signs. Thus, when the outputs are equal and of opposite sign a null finding is shown on operator interface 26.

The operator may then adjust the barrel 14 of weapon 12 in elevation until a null signal is received between EL+ detector 50 and EL− detector 52. According to the invention, accurate boresighting is achieved when the null position is achieved in both elevation and azimuth, at which point, the output of EL+ detector 50 and EL− detector 52 will be equal and the output of AZ+ detector 54 and AZ− detector will be equal.

Modulation electronics 30 modulates the output of laser source 28 in a high frequency sinusoidal or square wave pattern which is demodulated by demodulation electronics 58 to separate the signal of laser source 28 from background noise light sources.

Once barrel 14 of weapon 12 is boresighted as discussed above, sight 16 can be adjusted in a conventional fashion to coincide with boresighted barrel 14 of weapon 12.

The invention may be embodied in other specific forms without departing from the spirit of the essential attributes thereof, therefore, the illustrated embodiments should be considered in all respects as illustrative and not restrictive, reference being made to the appended claims rather than to the foregoing description to indicate the scope of the invention.

1. A device usable with a weapon having a barrel, comprising:
an optical laser radiation source that emits laser radiation having a radially symmetric intensity profile declining in intensity from a center thereof;
a mounting structure operably coupled to the laser radiation source having structure that engages the barrel and secures the laser radiation source substantially coaxially with the barrel;
an optical receiver locatable remote from the weapon, the optical receiver including photodetectors located equidistant from and surrounding a central target site, the photodetectors being sensitive to the laser radiation emitted by the laser radiation source and each photodetector generating an electrical signal proportional to an intensity of the laser radiation received from the laser radiation source;
a signal processor that processes the electrical signals from the photodetectors to generate an intensity gradient indicating comparative intensity of the laser radiation that is detected by the photodetectors wherein the intensity gradient presents a null point when the intensity detected by at least two compared photodetectors is equal; and
a communicative link between the optical laser radiation source and the optical receiver.

2. The device as claimed in claim 1, wherein the optical receiver comprises four photodetectors including an azimuth pair and an elevation pair.

3. The device as claimed in claim 1, wherein the optical laser radiation source further comprises modulation electronics that modulates the laser radiation and the optical receiver further comprises demodulation electronics whereby the laser radiation is selectively identified from background noise and wherein the modulation electronics is operably coupled to the demodulation electronics via the communicative link.

4. The device as claimed in claim 1, further comprising an operator interface that presents indication to an operator directing the operator to adjust pointing of the barrel in at least one of azimuth and elevation toward the null point.

5. The device as claimed in claim 1, wherein the signal processor comprises at least two parallel circuits receiving signal input from at least two of the photodetectors and comparing the signal input from the at least two of the photodetectors to determine relative illumination falling on the at least two of the photodetectors.

6. The device as claimed in claim 5, wherein the signal processor assigns opposed signs to output of the at least two parallel circuits receiving signal input from the at least two of the photodetectors such that when the output of the at least two parallel circuits is equal the null point is achieved because of the opposed signs.

7. The device as claimed in claim 1, wherein the signal processor further comprises an azimuth channel and an elevation channel the azimuth channel comprising a first positive sub-channel and a first negative sub-channel and the elevation channel comprising a second positive sub-channel and a second negative sub-channel.

8. The device as claimed in claim 1, further comprising beam forming optics that disperse the laser radiation into a mildly diverging beam.

9. The device as claimed in claim 1, optical laser radiation source further comprises a laser diode coupled to a length of single mode optical fiber that acts as a mode stripper that removes higher order modes leaving only a radially symmetrical Gaussian mode exiting the single mode optical fiber.

10. A method of bore sighting a weapon having a barrel, the method comprising:
mounting an optical laser radiation source that emits laser radiation having a radially symmetric intensity profile declining in intensity from a center thereof coaxially in the barrel;
directing the laser radiation toward a distant target comprising an optical receiver including photodetectors located equidistant from and surrounding a central target site, the photodetectors being sensitive to the laser radiation emitted by the laser radiation source and each photodetector generating an electrical signal proportional to an intensity of the laser radiation received from the laser radiation source;
receiving signals from each of the photodetectors; and
electronically processing the signals to compare the signals from at least two of the photodetectors and to generate an intensity gradient indicating comparative intensity of the laser radiation that is detected by the photodetectors wherein the intensity gradient presents a null point when the intensity detected by at least two compared photodetectors is equal.

11. The method as claimed in claim 10, further comprising receiving the signals from four photodetectors including an azimuth pair and an elevation pair.

12. The method as claimed in claim 10, further comprising electronically modulating the laser radiation at the optical laser radiation source and electronically demodulating the signals received from the photodetectors to selectively identify the signal from background noise.

13. The method as claimed in claim 10, further comprising presenting information based on the processing of the signals at an operator interface that directs an operator to adjust pointing of the barrel in at least one of azimuth and elevation toward the null point.

14. The method as claimed in claim 10, further comprising receiving signal input from at least two of the photodetectors and comparing the signal input from the at least two of the photodetectors to determine relative illumination falling on the at least two of the photodetectors.

15. The method as claimed in claim 10, further comprising assigning opposed signs to output of the at least two parallel circuits receiving signal input from the at least two of the photodetectors such that when the output of the at least two parallel circuits is equal the null point is achieved because of the opposed signs.

16. The method as claimed in claim 10, further comprising processing the signals via an azimuth channel and an elevation channel the azimuth channel comprising a first positive sub-channel and a first negative sub-channel and the elevation channel comprising a second positive sub-channel and a second negative sub-channel.

17. The method as claimed in claim 10, further comprising directing the laser radiation through a length of single mode optical fiber that acts as a mode stripper that removes higher order modes leaving only a radially symmetrical Gaussian mode exiting the single mode optical fiber.

18. The method as claimed in claim 10, further comprising directing the laser radiation through beam forming optics that disperse the laser radiation into a mildly diverging beam.
